(19) United States
(12) Patent Application Publication
(10) Pub. No.: US 2003/0008120 A1
(43) Pub. Date: Jan. 9, 2003

(54) Multilayered systems having optical properties

(75) Inventors: Stephanie Andes, Hanau (DE); Gerald Fuchs-Pohl, Weiterstadt (DE); Martin Friz, Darmstadt (DE); Ute Honeit, Darmstadt (DE); Gerhard Pfaff, Munster (DE); Michael Uhlig, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/166,713

(22) Filed: Jun. 12, 2002

(30) Foreign Application Priority Data
Jun. 12, 2001 (DE) 101 28 491.8

(51) Int. Cl. B32B 9/00

(52) U.S. Cl. 428/212; 428/472; 428/701; 428/698; 428/699; 428/697

(57) ABSTRACT

Multilayered systems having optical properties based on metallic substrates comprise both a layer (A) of at least two dielectric materials of different refractive index, where the refractive index at the lower side and the refractive index at the upper side of layer (A) are different, and a selectively or non-selectively absorbent layer (B).

### The invention relates to multilayered systems having optical properties based on metallic substrates, to a process for their production, and to their use.

Multilayered systems having optical properties which contain central layers of reflective materials, preferably metals, are known, in particular, in pigment form and are widely used in many areas of industry, for example for the production of automotive paints and decorative coating materials and for the pigmentation of plastics, paints, printing inks, in particular for security printing, paper and the like.

JP H7-759(A) discloses a multilayered interference pigment having metallic lustre which consists of a substrate of aluminium, gold or silver platelets or platelets of mica or glass which are coated with metals, and alternating layers of titanium dioxide and silicon dioxide located thereon. This pigment has high hiding power. However, the metallic core reflects the incident light to a very great extent, and consequently the interference effect caused by the metal oxide layers is only evident to a very small extent and the hard metallic lustre dominates the appearance of the pigments.

U.S. Pat. No. 4,434,010 describes optical layer systems having a central layer of an opaque, reflective material, for example aluminium, gold, copper or silver, which are coated on both sides with a first layer of a low-refractive-index, dielectric material, such as silicon dioxide, magnesium fluoride or aluminium oxide, and a second, semi-opaque metal layer of chromium, nickel or Inconel.

These layer systems are employed primarily for the printing of security documents or for the production of anti-counterfeiting materials and exhibit colours which vary with the viewing angle. If employed as pigments, however, they are not completely surrounded by the outer layers on all sides of the metal core owing to their production process, which can result in processing problems in coating solutions.

A multilayered interference film which has a colour shift and can be used for the production of pigments is described in U.S. Pat. No. 6,157,489. This film has a central reflection layer of aluminium, silver, copper or the like to which layers of high-refractive-index dielectric materials, such as, for example, titanium dioxide, zinc sulfide or yttrium oxide are applied on both sides, and an absorption layer of chromium, nickel, palladium, titanium, etc., is applied thereto. If they are to be employed in pigment form, these multilayered interference films likewise have substrates which are not completely surrounded by the outer layers, which again means that processing problems can occur.

DE 44 37 753 discloses multicoated metallic lustre pigments which have, on metallic substrates, a layer pack comprising

(A) a colourless coating having a refractive index n of ≦1.8 and

(B) a selectively absorbent coating having a refractive index n of ≧2.0 and, if desired, additionally

(C) an outer, colourless or selectively absorbent coating which is different from the underlying layer (B).

Layer (A) here consists, for example, of silicon dioxide, aluminium oxide or magnesium fluoride, while layer (B) is composed of selectively absorbent, high-refractive-index oxides or of “tinted” colourless high-refractive-index oxides. These pigments are said to have interesting coloristic properties and be suitable for producing a colour flop, i.e. a varying coloured appearance depending on the viewing angle.

A common feature of the pigments and layer systems disclosed in the three last-mentioned publications is that the interference colour of the pigments is determined essentially by the refractive index and thickness of the first layer on the metallic substrate, which has either a low or high refractive index, and by the colour absorption of the layer located thereon. The angle dependence and the colour intensity of the interference colour are, by contrast, controlled only by the composition and thickness of the first layer. In particular, the colour intensity and the number of hues passed through and the brightness of the colours are highly dependent on the material composition of the first layer. Influencing means by means of which fine adjustment of the colour brightness or of the intensity of the interference colours in the colour range passed through can be carried out are therefore missing.

EP 0 632 821 discloses coloured pigments based on platelet-shaped substrates which are covered with layers comprising TiO₂, one or more titanium suboxides and at least one oxide of at least one other metal and/or nonmetal, where the concentration of the titanium oxides in the coating layer is high in the vicinity of the substrate surface and drops gradually towards the pigment surface. The substrate may be a TiO₂-coated metal platelet, and the coating layer may comprise SiO₂ in addition to TiO₂ and the titanium suboxides. In this case, the TiO₂ layer present on the substrate is reduced by means of metallic Si in order to produce the titanium sub-oxide(s), with the simultaneous formation of SiO₂, which forms a protective layer on the pigment surface. Besides good hiding power, these pigments also have high electrical conductivity, but do not exhibit colour changes depending on the illumination or viewing angle.

An object of the invention is therefore to provide multilayered systems having optical properties based on metallic substrates which have high hiding power, high colour intensity and/or colours of high brightness at the same time as angle dependence of the interference colour, and whose desired colour properties can be adjusted in a simple manner, and to provide a process for their production and to indicate suitable potential uses.

Upon further study of the specification and appended claims, further objects and advantages of this invention will become apparent to those skilled in the art.

These objects are achieved in accordance with the invention by multilayered systems having optical properties comprising a metallic substrate and a plurality of layers comprising, in this sequence,

(A) a layer of at least two dielectric materials of different refractive index on the substrate, with a lower side facing the substrate and an upper side facing a subsequent layer, where the refractive index on the lower side and the refractive index on the upper side of the layer are different, and

(B) a selectively or non-selectively absorbent layer.

The multilayered systems according to the invention may optionally comprise an additional outer layer (C).

The invention likewise relates to a process for the production of the above-defined multilayered systems in which metallic substrates are coated with layers (A), (B) and optionally (C) by wet-chemical methods by precipitation, hydrolysis and/or reduction of metal salts in aqueous or organic medium and/or by CVD or PVD methods.

The invention additionally also relates to the use of the multilayered systems defined above in paints, coatings, printing inks, plastics, cosmetic formulations, ceramic materials, paper, films, packaging materials, glasses, pigment preparations, dry preparations, in security applications and for laser marking.

The metallic substrate is highly reflective and may comprise all metals and alloys known for metal effects, for example iron, steel, in particular stainless steel, aluminium, copper, nickel, chromium, zinc, tin, silver, gold, platinum, cobalt, lanthanides and titanium, and mixtures or alloys of two or more metals, such as brass or bronzes.

Substrates in accordance with the present invention are metallic layers in the form of films or particles.

If the substrate is in the form of particles, all known commercially available metal powders which are substantially stable in water or can be stabilised by suitable measures are particularly suitable. These metal powders are generally platelet-shaped.

Preference is given here to platelet-shaped aluminium particles, which are accessible in a simple manner by conventional techniques, such as the stamping-out of foils or by atomisation and grinding methods. It is also possible for aluminium foils to be broken and ground, or coarse aluminium particles are comminuted to the desired size and subsequently classified. For the production of particles of this type, the processes described in U.S. Pat. No. 3,949,139 and WO 00/24946 are particularly suitable.

If, however, standard commercial products made from the above-mentioned metals are employed, their surfaces should be substantially grease-free, which can be achieved by treatment with suitable solvents or by oxidative treatment, for example as described in DE-A42 23 384. It is also preferred for the metallic substrates to be subjected to a passivation treatment before the coating, as described, for example, in DE 42 36 332 and DE 44 14 079. This facilitates the use of the multilayered systems in pigment form according to the invention also in aqueous coating systems without problems.

The size of the metallic substrate particles is matched to the particular application of the pigment-form multilayered systems according to the invention and is not crucial per se. The average diameter of the substrate particles is usually in the range from about 1 to 250 μm, preferably from 2 to 200 μm and in particular from 5 to 50 μm, while the average thickness is between 0.02 and 3 μm, preferably between 0.05 and 2 μm.

The specific surface area, measured by the BET method, is generally 0.5-30 m²/g.

If aluminium platelets are employed, these generally have an average thickness of from greater than 0.05 to 1 μm, an average diameter of from 2 to 100 μm and a specific BET surface area of from 0.5 to 30 m²/g.

If the substrate is in the form of a film, it may be either opaque to light or partially transparent to light. In general, the layer thickness of these substrates is from 0.005 to 2 μm.

The substrate here is coated either on one or both sides with layers (A) and (B) and optionally (C). In this way, asymmetrical or symmetrical multi-layered systems having optical properties are obtainable.

Systems of this type can advantageously be produced using conventional PVD vacuum belt coating methods.

As a consequence of the process, the films are initially in the form of large areas and can be directly used further in this form, or converted into the desired use form by suitable measures. Suitable for this purpose are, in particular, methods such as grinding, stamping, cutting, embossing and the like.

Suitable materials of different refractive index for layer (A) are both the known materials having refractive indices of n≦1.8, known as low-refractive-index materials, and the known materials having refractive indices of n>1.8, known as high-refractive-index materials. The difference in the refractive index n in the materials employed should be at least 0.1, but preferably at least 0.3. It is not stipulated here which of the two sides of layer (A) has the higher refractive index.

It can be determined, depending on the desired colour effects, whether the lower side of layer (A) is to have a lower or higher refractive index than the upper side of layer (A). With increasing thickness of layer (A), either an increase or reduction in the refractive index, which can take place continuously or stepwise, but preferably takes place continuously, therefore occurs, regarded from the substrate. This is achieved via a structure of layer (A) in which, depending on the separation from the substrate surface, different concentrations of materials of lower or higher refractive index are present.

For example, exclusively a material of lower refractive index is present on the lower side of layer (A) facing the substrate, but its concentration decreases over the thickness of the layer as far as the upper side of layer (A) facing the subsequent layer, while at the same time the concentration of a further material of higher refractive index increases in such a way that this is present as the only material on the upper side of layer (A). In the same way, a structure of layer (A) in the reverse sequence of the refractive indices is possible, i.e. the concentration of a material of higher refractive index is high on the lower side of the layer and decreases over the layer thickness towards the upper side of the layer, while at the same time the concentration of a material of lower refractive index increases.

It is not a prerequisite that at least one of the materials of different refractive index is present alone on one side of layer (A). Instead, a mixture of two or more materials of different refractive index may already be present on the lower side of layer (A), with their ratio to one another varying over the thickness of layer (A) towards the upper side, but with a mixture still being present on the upper side. Thus, it is possible, for example, in the case of two materials of different refractive index, for the ratio of the material of lower refractive index to the material of higher refractive index to be 20:1 on the lower side of layer (A) and 1:20 on the upper side of layer (A). However, all mixing ratios for which a significant difference in the refractive index, which is at least 0.1 and preferably at least 0.3, is evident between the lower side and the upper side of layer (A) are generally suitable.

A further embodiment of the present invention comprises, on the lower side of layer (A), a mixture of two or more materials of different refractive index whose ratio to one another varies over the thickness of layer (A) towards the upper side in such a way that the material whose concentration increases from the lower side towards the upper side of layer (A) is present as the only material on the upper side. The reverse layer structure is likewise possible, in which, on the lower side of layer (A), a material is present alone whose concentration reduces over the thickness of layer (A), while the concentration of a further material of different refractive index increases in such a way that a mixture of the two materials is present on the upper side of layer (A).

Surprisingly, it has been found that the colour properties of the resultant multilayered system can be significantly affected by whether a material or material mixture of higher refractive index or a material or material mixture of lower refractive index is located on the lower side of layer (A) facing the substrate.

If a material or material mixture of lower refractive index whose concentration decreases with increasing layer thickness is firstly applied to the metallic substrate, while at the same time the concentration of a material or material mixture of higher refractive index increases, an increase in the intensity of the interference colour with constant colour brightness compared with individual layers of materials having refractive indices n of ≦1.8 and an increase in the intensity of the interference colour at the same time as improved colour brightness and at the same time as a broadened colour range in which an angle-dependent colour play can be observed (more hues are passed through), compared with individual layers of materials having refractive indices n of >1.8, can be observed compared with the application of layers of homogeneous composition, with an otherwise identical layer structure.

If, by contrast, in the reverse sequence, firstly a material or material mixture of higher refractive index whose concentration decreases with increasing layer thickness is applied to the metallic substrate, with at the same time the concentration of a material or material mixture of lower refractive index increasing, improved colour brightness with constant colour intensity compared with individual layers of materials having refractive indices n of ≦1.8 and an increase in the intensity of the interference colour with significantly improved colour brightness and at the same time broadened colour range in which an angle-dependent colour play can be observed, compared with individual layers of materials having refractive indices n of >1.8, can be observed compared with the application of layers of homogeneous composition, with an otherwise identical layer structure.

Through the arrangement of the sequence of application of materials of different refractive index and via the selection of the respective materials and the determination of the thickness of layer (A), a multiplicity of ways of being able specifically to produce optically attractive multilayered systems for a very wide variety of areas of application therefore arises for the person skilled in the art. The individual measures necessary for this purpose are generally known to the person skilled in the art and do not require an inventive step.

Suitable materials having a refractive index n of ≦1.8 are metal compounds, in particular metal oxides, metal fluorides, metal oxide hydrates, metal phosphates or mixtures thereof, which can be applied in a film-like and durable manner.

Examples thereof are SiO₂, SiO(OH)₂, Al₂O₃, AlO(OH), B₂O₃, MgF₂, AIF₃, CeF₃, LaF₃, MgSiO₃ or aluminium phosphate. However, it is also possible to employ organic monomers or polymers, for example acrylates, preferably methacrylates, and polytetrafluoroethylene.

Preference is given to SiO₂, Al₂O₃ and MgF₂ or mixtures thereof, and particular preference is given to SiO₂ and MgF₂.

The materials having a refractive index n of >1.8 employed are metal compounds, preferably metal oxides, metal sulfides, metal nitrides or metal carbides or mixtures thereof, for example TiO₂, ZrO₂, SiO, CeO₂, HfO₂, Pr₂O₃, Y₂O₃, Ta₂O₅, ZnO, SnO₂, Ce₂O₃, Fe₂O₃, Fe₃O₄, BiOCl, ZnS, TiN, Si₃N₄, SiC, but preferably TiO₂, ZrO₂ and Fe₂O₃ and in particular TiO₂. The latter may be present either in a rutile or an anatase modification.

Layer (A) has an optical layer thickness which preferably corresponds to an integer multiple of the incident light of wavelength λ/4, with the refractive index n being based on the refractive index of the materials of lower and higher refractive index averaged over the layer thickness. The thickness of layer (A) is generally from 100 to 1000 nm, and in particular from 150 to 600 nm.

The selectively or non-selectively absorbent layer (B) is not restricted with respect to the refractive index of the applied material or material mixture and can comprise both high-refractive-index and low-refractive-index materials. However, it is at least partially transparent to light (semi-opaque) and must therefore be carefully matched to the various materials employed with respect to its layer thickness.

Suitable materials are, in particular, metals, such as, for example, chromium, tungsten, cobalt, nickel, copper, molybdenum, iron, silver, gold, palladium, titanium, vanadium, niobium, platinum, but also aluminium and mixtures or alloys of two or more metals.

Likewise suitable, however, are also metal oxides, in particular those which are absorbent per se, but also those which can be rendered absorbent by incorporation of or coating with absorbent materials.

Particularly suitable metal oxides here are the various iron oxides, such as magnetite, goethite or iron(III) oxides of various modifications, various cobalt oxides (CoO, Co₃O₄), chromium(III) oxide, titanium(III) oxide and the known coloured titanium suboxides, various vanadium oxides (VO₂, V₂O₃), or also mixed oxides, such as pseudobrookite (Fe₂TiO₅) and ilmenite (FeTiO₃) and mixtures thereof.

Metal oxides which can be rendered absorbent by incorporation of absorbent particles, such as carbon black or carbon, or by incorporation of selectively absorbent colorants, by doping with metal cations or by coating with a film comprising a colorant are, for example, zirconium dioxide or titanium dioxide, which can likewise be employed as a mixture with one or more of the above-mentioned substances.

For layer (B), however, it is also possible to employ metal sulfides, such as cobalt sulfide, nickel sulfide, chromium sulfide, iron sulfide, tungsten sulfide, molybdenum sulfide, cerium sulfide, and mixtures thereof with one another or with metal oxides or metals, and also metal nitrides, such as titanium nitride or titanium oxynitride.

The layer thickness of layer (B) is determined by the material employed and the requirement that this layer must be at least partially transparent to visible light.

For non-selectively absorbent materials, the thickness of this layer is from about 5 to 100 nm, with the lower range from 5 to 25 nm, in particular from 5 to 20 nm, being sufficient for strongly absorbent metals, such as chromium and molybdenum.

If, by contrast, selectively absorbent metal oxides are employed, the thickness of layer (B) can be from 5 to 500 nm, preferably from 10 to 100 nm.

In the present invention, layer (B) preferably consists of chromium having a layer thickness of from 5 to 20 nm, of Fe₂O₃ having a layer thickness of from 10 to 100 nm, or of aluminium having a layer thickness of from 5 to 30 nm.

The selectively or non-selectively absorbent layer (B) attenuates the reflection of the incident visible light at the metallic substrate and amplifies the colour effect set by layer (A). In particular in the case of incorporation of the multilayered systems according to the invention in the form of pigments into the conventional coloured coating systems, the optical advantages of these pigments, such as increased intensity of the interference colours together with high hiding power and metallic lustre, as well as expanded colour ranges for the colour flop and/or high brightness of the colours, are therefore shown to their best advantage.

The multilayered systems according to the invention may optionally also have an outer protective layer (C). This is preferably intended to protect the underlying layer (B) and to stabilise the multilayered systems in this way. This is necessary, in particular, if the multilayered systems according to the invention are employed in pigment form.

Materials which can be employed for the outer layer (C) are colourless or selectively absorbent metal oxides, such as, for example, SiO₂, SiO(OH)₂, Al₂O₃, AlO(OH), SnO₂, TiO₂, ZrO₂, CeO₂, Fe₂O₃ or alternatively Cr₂O₃, which may also be chromate-, vanadate- or phosphate-containing. However, it is also possible to carry out an aftertreatment, which is intended both to increase the chemical stability of the multilayered systems and to improve their handling, in particular to simplify incorporation of pigment-form multilayered systems into various media.

Particularly suitable methods for this purpose are those described in DE 22 15 191, DE 31 51 354, DE 32 35 017, DE 33 34 598, DE 40 30 727, EP 0 649 886, WO 97/29059, WO 99/57204 or U.S. Pat. No. 5,759,255. Layer (C) generally has a thickness of from about 1 to 500 nm.

The multilayered systems according to the invention may also contain an additional dielectric layer consisting of metal oxides, metal fluorides, metal sulfides, metal nitrides or mixtures thereof between the metallic substrate and layer (A).

The process for the production of the lustre pigments according to the invention may be either a process in which all layers (A), (B) and (C), in particular layer (A) and layer (B), are applied to the platelet-shaped metallic support by wet-chemical methods by precipitation, hydrolysis and/or reduction of inorganic or organic metal compounds, or a process in which both layers (A) and (B) to be applied are applied by gas-phase decomposition of suitable compounds or by a PVD method, or a process in which a plurality of methods are employed in combination, depending on the composition of layers (A) and (B).

A wet-chemical process only comes into question both for layer (A) and for layer (B) if, besides layer (A), layer (B) is also composed of materials which can be deposited by wet-chemical methods, for example, selectively absorbent metal oxides, but also certain metals, and if a particulate substrate is employed.

Suitable wet-chemical methods here are precipitation, hydrolysis and/or reduction of organometallic or inorganic metal compounds, using the coating methods developed for the production of pearlescent pigments; methods of this type are described, for example, in DE 14 67 468, DE 19 59 988, DE 20 09 566, DE 22 14 545, DE 22 15 191, DE 22 44 298, DE 23 13 331, DE 25 22 572, DE 31 37 808, DE 31 37 809, DE 31 51 343, DE 31 51 354, DE 31 51 355, DE 32 11 602, DE 32 35 017 or alternatively in further patent documents and other publications.

In the case of precipitation of inorganic metal compounds onto particulate substrates, the substrate particles are suspended in water, and one or more hydrolysable metal salts are added at a pH which is suitable for the hydrolysis, this pH being selected in such a way that the metal oxides or metal oxide hydrates are precipitated directly onto the particles without secondary precipitations occurring. The pH is usually kept constant by simultaneous metering-in of an acid or base. The pigments are subsequently separated off, washed and dried and, if desired, calcined, it being possible for the temperature to be optimised with respect to the coating present in each case. If desired, the pigments may be separated off, dried and, if desired, calcined after application of individual coatings and then re-suspended for the application of the further layers by precipitation.

With the aid of this method, layer (A) can be applied to the substrate in such a way that either a stepwise or continuous change in the refractive index takes place within the layer. If, for example, it is intended for the refractive index to increase over the layer thickness, regarded from the substrate, the first step is precipitation onto the substrate of a material of lower refractive index or a mixture in which the material of lower refractive index predominates. As the reaction progresses, either a material of higher refractive index can be metered in continuously, with the amount of the material of lower refractive index being reduced constantly, or new mixing ratios of mixtures of the material of lower refractive index and of the material of higher refractive index are each added in portions in short time intervals, with very thin individual layers, each having a different mixing ratio of the two components, being formed. In the same way, a reversed layer build-up can take place.

In practice, the process described in J. Mater. Chem., 2001, 11, 984-986, has proven advantageous for this purpose.

Organometallic compounds, such as, for example, metal alkoxides, are hydrolysed in the presence of the substrate particles and in the presence of an organic solvent which is miscible with water and in which the metal compounds are soluble. If, for example, tetraethoxysilane or aluminium triisopropoxide is used, these can be hydrolytically decomposed in the presence of an alcohol, in particular isopropanol, and in the presence of aqueous ammonia as catalyst. In this way, the substrate can be coated with an SiO₂ or Al₂O₃ layer. This process is described in greater detail in DE 44 05 492.

An organic compound of a material of higher refractive index, for example tetrabutyl orthotitanate or tetraethyl orthotitanate, is metered into this solution little by little, while the feed of tetraethoxysilane or aluminium triisopropoxide is reduced.

The materials can also be applied in the reverse sequence.

Furthermore, the individual layers of the pigments according to the invention can also be deposited in a fluidised-bed reactor by gas-phase coating, using correspondingly, for example, the processes proposed in EP 0 045 851 and EP 0 106 235 for the production of pearlescent pigments.

The individual layers may also be produced by known methods by sputtering of metals, for example of aluminium or chromium or of alloys, such as, for example, chromium/nickel alloys, and of metal oxides, for example of titanium oxide, silicon oxide or indium tin oxide, or by thermal evaporation of metals or metal oxides.

The application of the layers by vapour deposition will be described in greater detail below:

The layer system can be produced on the substrate using a vapour deposition unit consisting of the conventional components, such as a vacuum chamber, a vacuum pump system, pressure measurement and control units, evaporator devices, such as resistance evaporators or electron-beam evaporators, an apparatus for establishing certain pressure conditions and a gas inlet and control system for oxygen.

The high-vacuum vapour deposition technique is described in detail in Vakuum-Beschichtung, Volumes 1-5; Herausgeber Frey, Kienel and Löbl, VDI-Verlag 1995.

The application of the layers by the sputtering method is carried out as follows:

In the sputtering method or cathode sputtering, a gas discharge (plasma) is ignited between the support and the coating material, which is in the form of plates (target). The coating material is bombarded by high-energy ions from the plasma, for example argon ions, and thereby removed or sputtered. The atoms or molecules of the sputtered coating material are precipitated on the substrate and form the desired thin layer. For application of a mixture of, for example, two different coating materials of different refractive index, two different targets are present simultaneously and are precipitated on the substrate in different concentrations due to different energy supplies.

In this case, either the energy supply is increased or reduced continuously, or certain mixing ratios are each deposited in portions and are changed by re-adjustment of substance amounts or energy supply at short intervals.

Metals or alloys are particularly suitable for sputtering methods. These can be sputtered at comparatively high rates, in particular in the so-called DC magnetron process. Compounds, such as oxides or suboxides, or mixtures of oxides can likewise be sputtered using high-frequency sputtering. The chemical composition of the layers is determined by the composition of the coating material (target). However, it can also be affected by additives to the gas which forms the plasma. In particular, oxide or nitride layers are produced by addition of oxygen or nitrogen in the gas space.

The structure of the layers can be influenced by suitable measures, such as bombardment of the growing layers by ions from the plasma.

The sputtering method is likewise described in Vakuum-Beschichtung, Volumes 1-5; Herausgeber Frey, Kienel and Löbl, VDI-Verlag 1995.

On use of particulate substrates, adaptation of the high-vacuum vapour deposition process to the substrate in powder form is absolutely necessary. To this end, it is necessary to keep the substrate in uniform motion during the vapour deposition process in the vacuum chamber in order to ensure homogeneous coating of all particle surfaces.

This is achieved, for example, by the use of rotating containers or the use of vibration devices.

Suitable for the production of large-area films are preferably continuous or discontinuous PVD vacuum belt coating methods in which the individual layers of the layer system are deposited one after the other. In this way, symmetrical or asymmetrical multilayered systems can be produced in accordance with the present invention.

If it is intended to produce a film-like multilayered system, a suitable belt-shaped support must be present. This support is a flexible material which is transparent or opaque, preferably transparent, for example, a polyester, such as polyethylene terephthalate. Depending on the desired further use of the multilayered system according to the invention, this support is preferably coated with a release layer which is soluble in a solvent or on heating if the multilayered system is to be used further detached from the support and optionally in pigment form. However, the support may, even without further pre-coating, be coated immediately with the multilayered system according to the invention if a use is intended in which the multilayered system according to the invention is to be used in the form of relatively large areas or strip-shaped, circular or similar areas.

It is likewise possible to provide the support both with a release layer and with an adhesive layer before the multilayered system according to the invention is deposited. In this case, the multilayered system can be detached from the support as a film and subsequently applied in film form to other materials by means of the adhesive layer.

It goes without saying that in order to produce a symmetrical multilayered system of the type in accordance with the invention on an optionally pre-coated belt-shaped support, firstly the outer layer of the system, i.e. optionally layer (C), and subsequently layers (B), (A), the metallic substrate, layers (A), (B) and optionally layer (C) are then applied.

In order to produce an asymmetrical multilayered system, the support is, if desired, pre-coated with the above-mentioned functional layers (release and/or adhesive layers), and layers (A), (B) and optionally (C) are subsequently applied in such a way that the layer sequence is different on the two sides of the substrate.

If the multilayered systems according to the invention are in the form of pigments, they are compatible with a multiplicity of colour systems, preferably from the area of paints, coatings and printing inks. These pigments are furthermore also suitable in plastics, ceramic materials, paper, glasses, for the laser marking of paper and plastics, in security applications, films and packaging materials, and for applications in the agricultural sector, for example for greenhouse sheeting. Owing to their high tinting strength, they can also, in particular, advantageously be employed in cosmetic formulations, for example in decorative cosmetics. They are likewise suitable for the production of pigment preparations and dry preparations, such as, for example, granules, chips, pellets, briquettes, etc., which are used, in particular, in printing inks and paints.

Dry preparations are granules, chips, pellets, briquettes, etc., which are composed of one or more of the inventive multilayered systems in pigment form, one or more binders, and one or more additives. They are made from pastes, containing these ingredients and a solvent or diluent, by drying the paste and then bringing them into the desired shape.

For the various applications, the multilayered systems in pigment form can also advantageously be employed in mixtures with commercially available dyes and pigments, for example organic dyes, organic pigments or other pigments, such as, for example, transparent and opaque white, coloured and black pigments, and with platelet-shaped iron oxides, organic pigments, holographic pigments, LCPs (liquid crystal polymers), and conventional transparent, coloured and black lustre pigments based on metal oxide-coated mica and SiO₂ platelets, etc. The multilayered pigments can be mixed with commercially available pigments, binders and fillers in any ratio.

If the multilayered systems according to the invention are employed in film form, they are particularly suitable for the production of or directly as films and packaging materials. These are taken to mean, in particular, cold-embossing films, hot-embossing films, lamination films, decorative films, coating films, shrink films or parts thereof.

Particular importance is also attached to use in security applications, for example as security threads or strips for banknotes, securities, identity cards, cash cards, identity card holders or the like.

The multilayered systems according to the invention have high hiding power and exhibit intense interference colours. Depending on the sequence of the applied materials of higher or lower refractive index, colour effects, such as, for example, a broadening of the colour range in which colour changes can be observed depending on the illumination or viewing angle, or, however, particular colour brightness with soft colour transitions can be set specifically. These advantages are particularly useful, for example, in the conventional coloured coating systems which comprise conventional binders and additives.

By means of simple coating technologies, it is therefore possible to provide attractive multilayered systems having optical properties which can advantageously be employed in many areas of application.

The complete disclosure content of all patent applications, patents and publications mentioned above, including the corresponding German patent application DE 101 28 491.8, is incorporated into this application by way of reference.

The following examples are intended to explain the invention in greater detail, but without restricting it.

In the foregoing and in the following examples, all temperatures are set forth uncorrected in degrees Celsius; and, unless otherwise indicated, all parts and percentages are by weight.

### EXAMPLES

### Example 1

Firstly, solutions A and B are prepared separately from one another.

To this end, 0.5 mol/l of (NH₄)₂TiF₆ is dissolved in demineralised water for solution A and 0.5 mol/l of (NH₄)₂SiF₆ is dissolved in demineralised water for solution B. The two solutions each additionally comprise 1 mol/l of H₃BO₃.

75 g of passivated aluminium flakes having a particle size of 10-50 μm and an average layer thickness of 300 nm are suspended in 1.75 l of solution A, warmed to 30° C. and stirred at this temperature for 5 hours (pre-treatment time).

2.33 l of solution B are subsequently metered in at a constant metering rate over a period of 20 hours. Simultaneously, a corresponding amount of mixed solution is removed in a controlled manner in order to keep the reaction solution constant at a volume of about 2 l. When the reaction time is complete, the mixture is allowed to cool to room temperature, and the pigment obtained is filtered off, washed with demineralised water until salt-free and dried at 110° C.

The powder is then calcined at 500° C. for 30 minutes.

A Cr layer with a thickness of 5 nm is subsequently deposited by a PVD process.

The finished pigment exhibits an intensely coloured gold hue with a particularly smooth colour transition via green to blue.

### Example 2

Firstly, solutions A and B are prepared separately from one another.

To this end, 0.5 mol/l of (NH₄)₂SiF₆ is dissolved in demineralised water for solution A and 0.5 mol/l of (NH₄)₂TiF₆ is dissolved in demineralised water for solution B. The two solutions each additionally comprise 1 mol/l of H₃BO₃.

75 g of passivated aluminium flakes having a particle size of 10-50 μm and an average layer thickness of 300 nm are suspended in 2.33 l of solution A, warmed to 30° C. and stirred at this temperature for 3 hours (pre-treatment time).

1.75 l of solution B are subsequently metered in at a constant metering rate over a period of 10 hours. Simultaneously, a corresponding amount of mixed solution is removed in a controlled manner in order to keep the reaction solution constant at a volume of about 2 l. When the reaction time is complete, the mixture is allowed to cool to room temperature, and the pigment obtained is filtered off, washed with demineralised water until salt-free and dried at 110° C.

The powder is then calcined at 500° C. for 30 minutes.

A Cr layer with a thickness of 5 nm is subsequently deposited by a PVD process.

The finished pigment exhibits an intensely coloured gold hue with a particularly smooth colour transition to cyan.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A multilayered system having optical properties comprising: a metallic substrate and a plurality of layers comprising, in the following sequence,
(A) a layer of at least two dielectric materials of different refractive index on the substrate, with a lower side facing the substrate and an upper side facing a subsequent layer, where the refractive index on the lower side and the refractive index on the upper side of the layer are different, and
(B) a selectively or non-selectively absorbent layer which is at least partially trasnparent.

2. A multilayered system according to claim 1, in which the metallic substrate is platelet-shaped.

3. A multilayered system according to claim 1, in which the metallic substrate is in the form of a film.

4. A multilayered system according to claim 1, further comprising an additional outer layer (C).

5. A multilayered system according to claim 2, further comprising an additional outer layer (C).

6. A multilayered system according to claim 3, further comprising an additional outer layer (C).

7. A multilayered system according to claim 1, wherein the refractive index increases from said lower side to said upper side of layer (A).

8. A multilayered system according to claim 1, wherein the refractive index of layer (A) decreases from said lower side to said upper side.

9. A multilayered system according to claim 7, wherein the refractive index of layer (A) increases continuously.

10. A multilayered system according to claim 8, wherein the refractive index of layer (A) decreases continuously.

11. A multilayered system according to claim 7, wherein the refractive index of layer (A) increases in a stepwise manner.

12. A multilayered system according to claim 8, wherein the refractive index of layer (A) decreases in a stepwise manner.

13. A multilayered system according to claim 1, wherein the refractive indices of two dielectric materials in layer (A) have a difference of at least 0.1.

14. A multilayered system according to claim 13, wherein the refractive indices of two dielectric materials in layer (A) have a difference of at least 0.3.

15. A multilayered system according to one claim 1, wherein the refractive index at the lower side of layer (A) and the refractive index at the upper side of layer (A) have a difference of at least 0.1.

16. A multilayered system according to claim 15, wherein the refractive index at the lower side of layer (A) and the refractive index at the upper side of layer (A) have a difference of at least 0.3.

17. A multilayered system according to claim 1, wherein said metallic substrate is comprised of metals, metal alloys or mixtures thereof.

18. A multilayered system according to claim 1, wherein layer (A) contains materials having a refractive index n of≦1.8.

19. A multilayered system according to claim 1, wherein layer (A) contains materials having a refractive index n of>1.8.

20. A multilayered system according to claim 1, in which layer (A) contains materials having a refractive index n of≦1.8 and materials having a refractive index n of>1.8.

21. A multilayered system according to claim 18, wherein the material having a refractive index n of≦1.8 is a metal oxide, metal fluoride, metal oxide hydrate, metal phosphate or a mixture thereof, or an organic monomer or polymer.

22. A multilayered system according to claim 20, wherein the material having a refractive index n of≦1.8 is a metal oxide, metal fluoride, metal oxide hydrate, metal phosphate or a mixture thereof, or an organic monomer or polymer.

23. A multilayered system according to claim 19, wherein the material having a refractive index n of>1.8 is a metal oxide, metal sulfide, metal nitride, metal carbide or a mixture thereof.

24. A multilayered system according to claim 20, wherein the material having a refractive index n of>1.8 is a metal oxide, metal sulfide, metal nitride, metal carbide or a mixture thereof.

25. A multilayered system according to claim 22, wherein the material having a refractive index n of>1.8 is a metal oxide, metal sulfide, metal nitride, metal carbide or a mixture thereof.

26. A multilayered system according to claim 1, wherein the selectively or non-selectively absorbent layer contains an at least partially light-transparent metal or selectively absorbent metal oxide, metal sulfide, metal nitride, or an alloy or mixture thereof.

27. A multilayered system according to claim 17, in which the metallic substrate is made of iron, steel, stainless steel, aluminium, copper, nickel, chromium, zinc, tin, silver, gold, platinum, cobalt, a lanthanide, titanium, or a mixture or alloy thereof.

28. A multilayered system according to claim 21, in which the material having a refractive index n of≦1.8 is SiO₂, SiO(OH)₂, Al₂O₃, AlO(OH), B₂O₃, MgF₂, AlF₃, CeF₃, LaF₃, MgSiO₃, aluminium phosphate or a mixture thereof, or an acrylate, methacrylate or polytetrafluoro-ethylene.

29. A multilayered system according to claim 28, in which the material having a refractive index n of≦1.8 is SiO₂, Al₂O₃, MgF₂ or a mixture thereof.

30. A multilayered system according to claim 29, in which the material having a refractive index n of≦1.8 is SiO₂ or MgF₂.

31. A multilayered system according to claim 23, in which the material having a refractive index n of>1.8 is TiO₂, ZrO₂, SiO, CeO₂, HfO₂, Pr₂O₃, Y₂O₃, Ta₂O₅, ZnO, SnO₂, Ce₂O₃, Fe₂O₃, Fe₃O₄, BiOCl, ZnS, TiN, Si₃N₄, SiC or a mixture thereof.

32. A multilayered system according to claim 31, in which the material having a refractive index n of>1.8 is TiO₂, ZrO₂, Fe₂O₃ or a mixture thereof.

33. A multilayered system according to claim 32, in which the material having a refractive index n of>1.8 is TiO₂.

34. A multilayered system according to claim 26, in which the selectively or non-selectively absorbent layer (B) Is made of chromium, tungsten, cobalt, nickel, copper, molybdenum, aluminium or magnetite, goethite, iron(III) oxide, cobalt oxide, chromium(III) oxide, titanium(III) oxide, titanium suboxide, vanadium oxide, pseudobrookite, ilmenite or cobalt sulfide, nickel sulfide, chromium sulfide, iron sulfide, tungsten sulfide, molybdenum sulfide, cerium sulfide or titanium nitride or titanium oxynitride, or a mixture thereof or an alloy of two or more of the metals.

35. A multilayered system according to claim 34, in which the selectively or non-selectively absorbent layer (B) is made of chromium, aluminium or iron(III) oxide.

36. A multilayered system according to of claim 1, in the form of pigment particles.

37. A multilayered system according to claim 1, in the form of a film.

38. A process for the production of a multilayered system according to claim 1, comprising coating a metallic substrate with layers (A), (B) and optionally (C) by wet-chemical methods by precipitation, hydrolysis or reduction of metal salts in aqueous or organic medium, and/or by CVD or PVD methods.

39. A process according to claim 38, in which a flexible support is coated with the metallic substrate and then layers (A), (B) and optionally (C) are coated onto the substrate in such a way that layers (A), (B) and optionally (C) are applied symmetrically to both sides of the substrate or asymmetrically to only one side of the substrate by a PVD vacuum belt coating method.

40. In a paint, coating, printing ink, plastic, cosmetic formulation, ceramic material, paper, film, packaging material, glass, pigment preparation, dry preparation, security application, or laser marking, comprising a multilayered system the improvement wherein said multilayered system is in accordance with claim 1.
